(19) United States
(12) Patent Application Publication
(10) Pub. No.: US 2017/0267576 A1
(43) Pub. Date: Sep. 21, 2017

(54) Durable and Optically Transparent Superhydrophobic Surfaces

(71) Applicant: University of Florida Research Foundation, Inc., Gainesville, FL (US)

(72) Inventors: Wolfgang M. Sigmund, Gainesville, FL (US); Christian David Bohling, Denver, CO (US); Yung-Chieh Hung, Gainesville, FL (US)

(21) Appl. No.: 15/444,896

(22) Filed: Feb. 28, 2017

Related U.S. Application Data
(60) Provisional application No. 62/309,693, filed on Mar. 17, 2016.

(51) Int. Cl. C03C 17/25; B05D 7/04; C08J 7/06; B05D 5/08; C09D 5/16; C09D 7/12; B05D 3/10; B05D 7/24

(52) U.S. Cl. CPC C03C 17/25; B05D 3/101; B05D 7/04; B05D 7/24; B05D 5/08; C09D 5/1681; C09D 7/1225; C08J 7/065; C03C 2217/42; C03C 2217/213; C03C 2217/76; C03C 2218/111; C03C 2218/31; C03C 2218/32; C08J 2300/00

(57) ABSTRACT

Durable and optically transparent superhydrophobic surfaces have a coating of ceramic nanoparticles attached to a transparent substrate that are bound to the substrate through a flexible linker and a fluorocarbon moiety is bound to the surface of the ceramic nanoparticles. The nanoparticles provide the topography required for superhydrophobic surfaces and the fluorocarbon attached to the surface renders the particles hydrophobic. The nanoparticles can be metal oxide nanoparticles of dimensions that do not scatter light and the flexible linker can be constructed by an agent that has a group for bonding to the substrate and a reactive group to form a bond with a complementary second reactive group attached to a second agent that has a group for bonding to the nanoparticles.

### CROSS-REFERENCE TO A RELATED APPLICATION

This application claims the benefit of U.S. Provisional Application Ser. No. 62/309,693, filed Mar. 17, 2016, the disclosure of which is hereby incorporated by reference in its entirety, including all figures, tables and drawings.

### BACKGROUND OF INVENTION

Superhydrophobic surfaces are materials that bead water to near spherical droplets which easily roll across the surface and provide a self-cleaning effect by whisking away surface contaminants. Self-cleaning surfaces are especially desirable to reduced energy costs and reduced waste generation. However, superhydrophobic surfaces universally rely on microscopic surface topography for their effects, making them extremely vulnerable to wear, with only a few unique examples of hydrophobic ceramics able to stand up to limited amounts of repeated or continuous abrasion.

One strategy to prepare superhydrophobic surfaces is to form a nanoparticle assembly on a substrate. The most commonly used nanoparticles are silica nanoparticles prepared by a Stober method. The nanoparticles can be deposited by many different methods, including dip, spin, and spray coating. The nanoparticles can be deposited as multilayers. Multilayers of different sized nanoparticles have been employed, and raspberry-like particle assemblies, as taught in Ming et al. Nano Letters, 2005, 5, 2293-301, have been produced, where small aminosilane functionalized silica nanoparticles and epoxysilane treated large silica nanoparticles form a raspberry-like structure, that are fixed to an epoxy film followed by a polydimethylsiloxane (PDMS) coating to yield superhydrophobic surfaces. These opaque materials are disclosed to be made by a robust process, yet durability of the surface is not disclosed.

Simultaneously superhydrophobic and transparent surfaces are not common. Hydrophobicity imparting surface features typically scatter light and render the appearance opaque or translucent. To eliminate light intensity loss due to scattering, surface features typically need to decrease in size to about 100 nm or less. Furthermore, the mechanical stability is often poor as the smaller the surface feature, and larger the aspect ratio, the greater the risk of damage due to physical factors. Superhydrophobic transparent coatings examined have had difficulty with durability due to poor adherence to underlying substrates, or are not sufficiently hydrophobic due to a lack of nanoscale sharpness and porosity. Coatings based on nanoarrays or nanoparticles typically display poor homogeneity and durability due to adhesion to the underlying substrates. Fabrication often involves processing schemes that are unsuitable for large-scale production. Nevertheless, a durable, transparent superhydrophobic coating has an enormous number of industrial applications including coatings for commercial window glass, automotive glass, and solar panel coatings where in addition to water-proofing, inherent self-cleaning properties are desirable.

### BRIEF SUMMARY

Embodiments of the invention are directed to a superhydrophobic nanoparticle coated article where glass or ceramic nanoparticles are attached to a substrate's surface through a flexible linker and a fluorocarbon moiety is bound to at least the ceramic nanoparticles and possibly any portion of the surface not covered by the nanoparticles. The ceramic nanoparticles are metal oxide nanoparticles such as silicon oxide, aluminum oxide, or titanium oxide. The flexible linker has multiple covalent bonds that include a reaction product of a reaction functionality and its complementary reaction functionality, where a portion of the flexible linker connects the substrate to the reaction product and a portion of the flexible linker connects the ceramic nanoparticle to the reaction product. By proper choice of the substrate and the size of the nanoparticles, a transparent article can be constructed. Glass or ceramic nanoparticles of less than 200 nm in cross-section are useful for transparent surfaces. The fluorocarbon moiety is bound to at least the ceramic nanoparticle's surface as a plurality of fluorinated hydrocarbon moieties where each of the fluorinated hydrocarbon moieties is bound to the ceramic nanoparticles by at least one bond to impart superhydrophobicity to the surface.

Other embodiments of the invention are directed to methods of preparing the superhydrophobic nanoparticle coated article where a substrate's surface with a multiplicity of reactive groups is reacted with a multiplicity of a substrate surface functionalizing agent that has complementary reactive group that connects a functionality through a series of covalent bonds where the functionality and is accessible for subsequent reaction with a complementary functionality connected to a glass or ceramic nanoparticle through a series of covalent bonds to form a glass or ceramic nanoparticle decorated substrate. The glass or ceramic nanoparticle decorated substrate is then treated with a reagent that reacts with available reactive groups on the glass or ceramic nanoparticles' surfaces, and possibly the substrate's surface, to form fluorocarbon moieties on the surfaces to impart superhydrophobicity to the surfaces of the resulting nanoparticle coated article.

### BRIEF DESCRIPTION OF DRAWINGS

FIG. 1 shows a schematic of a nanoparticle attached to a surface via a flexible linker, according to an embodiment of the invention.

FIG. 2 is a reaction equation for forming a flexible linker between a nanoparticle and a glass surface, according to an embodiment of the invention.

FIG. 3 shows a photographic image of a water droplet of a fluorosilane coated nanoparticle decorated surface where a 155° contact angle is observed.

FIG. 4 shows an AFM height plot for a fluorinated silicon oxide particle coated glass slide where the nanoparticles are not attached via a flexible linker.

FIG. 5 shows an AFM height plot for a fluorinated silicon oxide nanoparticle coated glass slide where the nanoparticles are attached via a flexible linker having a nanoparticle aggregate surface formed by deposition of amino-silane coated nanoparticles aggregated with epoxy-silane coated nanoparticles.

FIG. 6 is an AFM height plot for a fluorinated silicon oxide particle coated glass slide where the nanoparticles are not attached via a flexible linker but formed by simultaneous deposition of 1:3 amino-silane:epoxy-silane treated nanoparticles.

FIG. 7 is an AFM height plot for a fluorinated silicon oxide particle coated glass slide where the nanoparticles are not attached via a flexible linker but formed by simultaneous deposition of 3:1 amino-silane:epoxy-silane treated nanoparticles.

### DETAILED DISCLOSURE

Embodiments of the invention are directed to articles with superhydrophobic surfaces that are transparent and durable. The articles obtain their superhydrophobic nature by the inclusion of ceramic nanoparticles that are chemically bonded to a coating on the substrate's surface. In embodiments of the invention organic linking moieties attach the nanoparticles to a surface where the linking moiety, also referred to herein as a flexible linker, provides flexibility to the otherwise hard superhydrophobic surface. By inclusion of the flexible linker, the superhydrophobic coating's surface resists damage by physical contact with an abrasive. The nanoparticles' ability to yield under applied stress while remaining bonded to the coating and surface allows a superior durability.

For transparency, the ceramic nanoparticles are less than about 200 nm in cross-section and can be any ceramic material, including, but not limited to, silicon oxide, titanium oxide, aluminum oxide, or any combination of ceramic nanoparticles. The ceramic nanoparticles can be treated with a functional organosilane to provide a reactive group through which the ceramic nanoparticles can be bound to a transparent substrate's surface. The transparent surface can be, for example, but not limited to, a glass surface or a plastic surface. The transparent substrate contains surface reactive groups that react to form bonds with complementary reactive groups that are attached to the functional organosilane and form the flexible linker.

In an embodiment of the invention, the surface of a glass substrate has a surface that contains a first functional group that is an epoxy group or an amino group and a second functional group attached to a silica nanoparticle can be an amino group or an epoxy group, respectively. Although many embodiments of the invention are disclosed herein with reference to glass substrates and silica nanoparticles, it should be understood that other metal oxide nanoparticles can be used, for example, but not limited to Al₂O₃, TiO₂, or any other metal oxide nanoparticles. The functional groups are provided by surface reaction with silanes comprising the functional group and a flexile alkylene between the Si atom of the silane and the functional group. Silanes can have the structure: XₙR₃₋ₙSi(CH₂)ₘG, where X is H, Cl, OR′, NR′₂, OC(O)R′, where R′ is C₁ to C₃ alkyl; R is C₁ to C₃ alkyl; G is epoxy, NH₂, NHR″, OH, or C(O)OR′″, where R′″ is C₁ to C₃ alkyl; n is 1 to 3; and m is 3 to 8. For example, the surface of a glass substrate can be treated with a solution of a silane comprising a functional group where there is sufficient concentration of the silane to condense with a sufficient portion, for example, more than 10% of the SiOH groups on a glass surface by reaction with a reactive group, X, of the silane.

Catalysts and/or acid or base scavengers can be included in the silane solutions. Catalysts can be acids or bases. Acids can be a Brönsted acid, or a Lewis acid. Bases can be tertiary amines, pyridines, or other bases. The solvent is chosen to be compatible with the silane and the surface to be treated, such that no reaction occurs between the solvent and the silane. Typically, organic solvents can be used, including, but not limited to, hydrocarbon solvents, aromatic solvents, alcohols, chlorinated hydrocarbons, ethers, and esters, as is appropriate for the silane, which would be readily apparent to one skilled in the art. The silica nanoparticles can be suspended in a solution of the silane with a complementary G group to the silane used for functionalizing the glass surface. The concentration of the silane in solution is provided to couple to a sufficient portion, for example, 10 to 90% of the SiOH groups on the silica nanoparticle surface, such that an adequate number of SiOH sites on the nanoparticles remain unreacted and available for subsequent coupling with a fluorosilane. In general, the proportion of silane and nanoparticles will depend upon the size of the nanoparticles, such that at least one surface SiOH has undergone a coupling reaction with a silane, but few, if any, silica nanoparticles have 100% of the SiOH functionalized with the silane. Silica nanoparticles that have not coupled with a silane can be removed from the nanoparticle decorated surface with the solvent used during reaction to form the flexible linker by washing. The proper amounts of silane use to functionalize the nanoparticles can be calculated from a known nanoparticle's surface SIOH or MOH content, or the proper amount can be determined experimentally by varying the proportions of silane to nanoparticles until the desired surface attachment after fluorosilane treatment is achieved.

Deposition of the complementary silane treated silica nanoparticles on the silane treated glass surface can be carried out by any deposition method, including dip-coating, spray coating, roll coating, or any other method of deposition from suspension in a liquid. Depending upon the nature of the silica nanoparticles and their size distribution, the nanoparticle surface coverage can be as high or higher than a monolayer of hexagonal closest packing depending upon the distribution of nanoparticle sizes. The nanoparticles can cover a significantly lower monolayer surface population than hexagonal closest packing monolayer. Depending upon the manner of deposition, size distribution of the particles, and choice of the complementary functionalities, the nanoparticles can organize into a particular distribution that is either ordered or random. The nanoparticles may be of any shape or combination of shapes, including but not limited to: spheres; ovids; cuboids; pyramids; cylinders; and prisms.

The nanoparticle decorated surface can be treated with a fluorosilane to render the surface superhydrophobic. In embodiments of the invention, the fluorosilane has the structure: XₙR₃₋ₙSi(CH₂)₂(F₂)ₘCF₃, where X is H, Cl, OR′, NR′₂, OC(O)R′, where R′ is C₁ to C₃ alkyl; R is C₁ to C₃ alkyl; n is 1 to 3; and m is 1 to 17. The fluorosilane reacts with any unreacted SiOH or MOH on the nanoparticles or on the glass substrate surface.

In an exemplary embodiment of the invention, the surface functionality can be an epoxy group or a primary or secondary amino group and the second functionality attached to the ceramic particle can be a primary or secondary amino group or an epoxy group, respectively. For example, a glass surface treated with (glycidoxypropyl)trimethoxysilane can be decorated with metal oxide nanoparticles where the nanoparticles' surfaces have been treated with (aminopropyl)trimethoxysilane. Amine addition to the epoxy groups with epoxy-ring opening can occur, such that there is at least one flexible linker with an eight-atom chain connecting the glass surface silane to the particle surface silane for each particle. To achieve superhydrophobicity, the nanoparticle decorated surface is treated with a fluorosilane, such as (heptadecafluoro-1,1,2,2-tetrahydrodecyl)trichlorosilane or 1H,1H,2H,2H-perfluorooctyltrimethoxysilane.

Alternatively, in an embodiment of the invention, the transparent surface can be exhaustively silylated with a functional silane, for example, an epoxy functionalized silane, and the silica nanoparticles can be exhaustively silylated with a complementary functional silane, for example, an amino functionalized silane. After attachment of the nanoparticles to the surface and removal, by washing, of unattached nanoparticles from the surface, the functional silane applied to the surface can be applied to the nanoparticle decorated surfaces such that the linking groups can present a silane at the nanoparticle surface. After hydrolyzing the silanes on the surface, the perfluorosilane can be applied to the nanoparticle surface to condense with the hydrolyzed silanes to yield a perfluorinated surface that is superhydrophobic.

The fluorosilane treatment can be carried out in any of a number of ways, including UV treatment, hydrogen peroxide treatment, or treatment with an additional silane to provide sites on the particulate coating surface to which the fluorosilane bonds. Once the fluorosilane is bound to the surface, the particle coating is extremely durable. Exemplary coatings display resistance to over 40,000 abrasion cycles such as the movement of a windshield wiper on a car windshield.

### Methods and Materials

Silicon oxide nanoparticles were grown by the Stöber process, where 8.33 g of tetraethyl orthosilicate (TEOS), 5 g of de-ionized water, and 0.98 g of 0.28N aqueous ammonium hydroxide solution were added to 100 mL of ethanol and agitated for 24 hours at 50° C. This process creates nanoparticles of about 40 nm in diameter, as measured by SEM.

A glass surface was functionalized with epoxy groups by submersion in solution of 20 μL (glycidoxypropyl)trimethoxy silane (GPTMS) in 50 mL ethanol. Silicon oxide particles, 0.5 g, were dispersed by ultra-sonication in 50 mL of ethanol, followed by the addition of 40 μL of (aminopropyl)trimethoxy silane (APTMS) with agitation for 20 minutes. Excess silane was removed by centrifuging the dispersion, pouring off the ethanol/silane solution, adding 50 mL of fresh ethanol, and repeating this process.

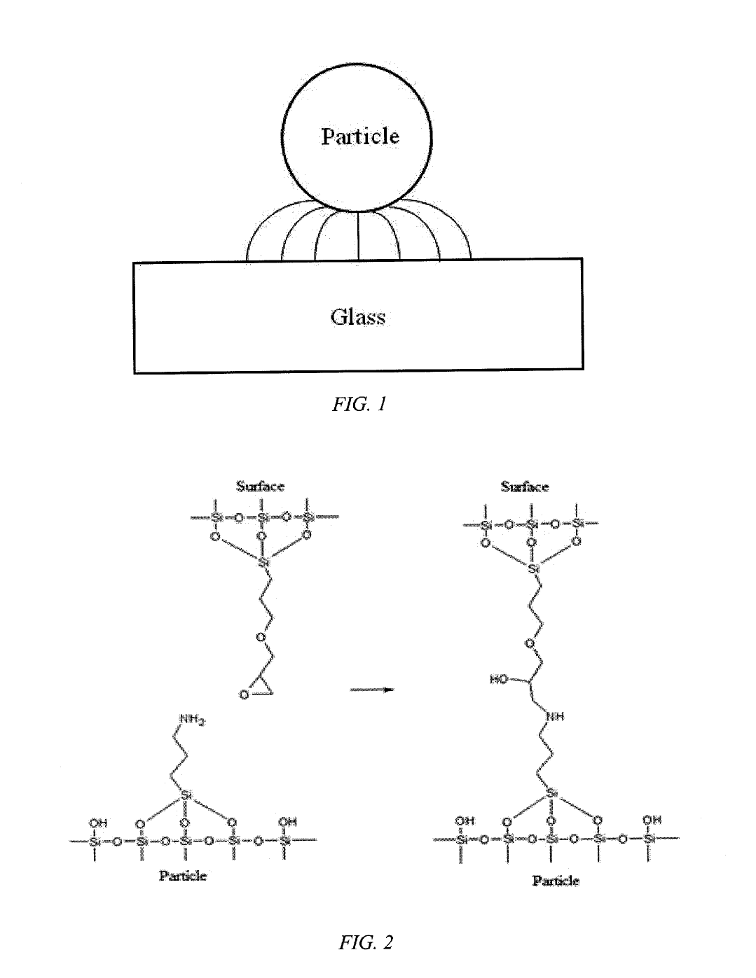

A glass slide is submerged in the freshly sonicated nanoparticle dispersion and agitated for 30 seconds. The slide was withdrawn and rinsed with ethanol to remove excess nanoparticles. Subsequently, the coated slide was submerged in basic solution of either 2 mL or 4 mL of 10N sodium hydroxide in 50 mL ethanol for 30 minutes. The slide was removed from the solution, rinsed with ethanol and allowed to dry. A schematic of the nanoparticle-surface attachment via a flexible linker is shown in FIG. 1. An epoxy ring-opening reaction equation to bond nanoparticles to a glass surface is given in FIG. 2.

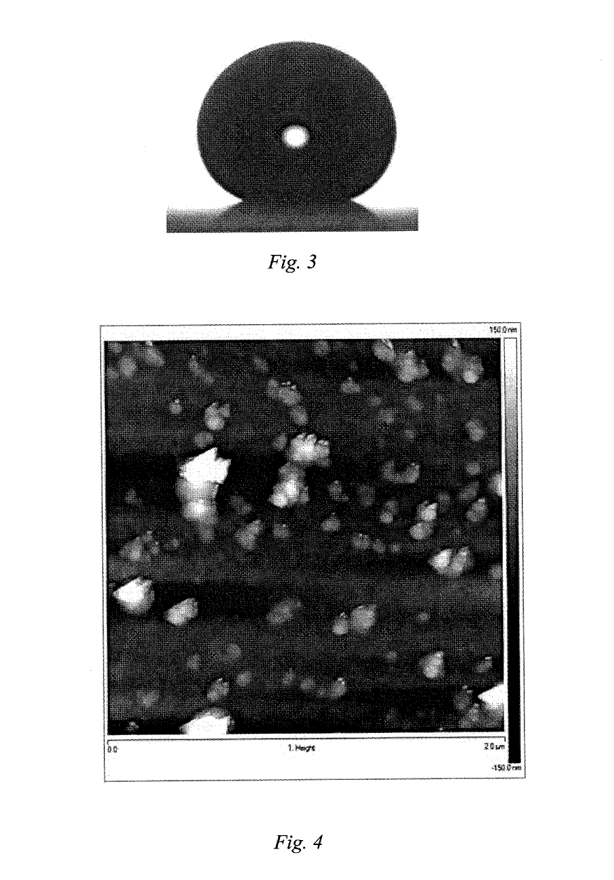

A portion of the nanoparticles were deposited on a glass slide and the surface treated with (heptadecafluoro-1,1,2,2-tetrahydrodecyl)trichlorosilane. The surface was superhydrophobic as illustrated in FIG. 3 by the water drop large contact angle of 155° The decorated surface showed a surface structure, as imaged by atomic force microscope, shown in FIG. 4 that showed a profile that varied by about 300 nm for the 40 nm nanoparticles decorating the surface.

Fluorosilane were attached to the nanoparticle decorated glass slides via addition of an epoxy functional silane, GPTMS, to the nanoparticle surfaces having attached APTMS to provide a silane functionality extending from the particles surface. These surface silanes were treated with the fluorosilane (heptadecafluoro-1,1,2,2-tetrahydrodecyl)trichlorosilane.

Contact angles of a bare glass slide coated with Rain-X and of glass slides submerged in a dispersed silica nanoparticle solution before and after subsequent treatment with fluorosilane were measured. These samples underwent durability testing by undergoing a series of abrasion cycles that emulate the typical movement of a windshield wiper across a windshield in the rain, where an approximately 1.5 inch segment of a windshield wiper is attached to a Linear Abraser—Model 5700 (Taber Industries) and run over the sample for 400, 4000, and 40000 cycles under a constant stream of water, with the contact angle of water on the sample measured after each cycle number. The interaction force between windshield wiper and surface was measured using a scale and was set to about 1.5 oz/inch of wiper blade, which is the typical interaction force between a full wiper blade and a car's windshield.

In another embodiment of the invention, ultraviolet radiation is applied to degrade the exposed unreacted silane groups from the surface of the nanoparticles. A fluorinated nanoparticle decorated surface was irradiated with ultraviolet light for an extended period of time to promote degradation of the aminopropyl functional groups on the surface of the nanoparticles to generate sites for attachment of fluorosilane. Table 1, below, gives results that indicate that although degradation occurred it was insufficient or that nanoparticle decoration was lost.

TABLE 1
Contact Angle vs. UV Exposure Time

| UV Treatment | Contact Angle After |
|---|---|
| (Hours) | Fluorosilane Treatment |
| 0 | ~30° |
| 24 | ~30° |
| 90 | 101° |

As indicated in Table 1, above, the contact angle for an APTMS-terminated particle coated slide is ˜30°. After treatment with GPTMS followed by deposition of the fluorosilane, the contact angle increased to 110°. This increase in contact angle indicates that hydroxysilicon functional groups appear to form at the nanoparticle surface to allow bonding of the fluorosilane.

To increase surface roughness without an increase of deposition steps, formation of nanoparticle agglomerates having a controlled size was examined by agglomeration of nanoparticles coated with epoxy-silanes with nanoparticles coated with amino-silanes followed by agglomerate deposition on an epoxy-silane functionalized surface and by simultaneous deposition of epoxy-silane and amino-silane coated nanoparticles on an epoxy-silane functionalized surface.

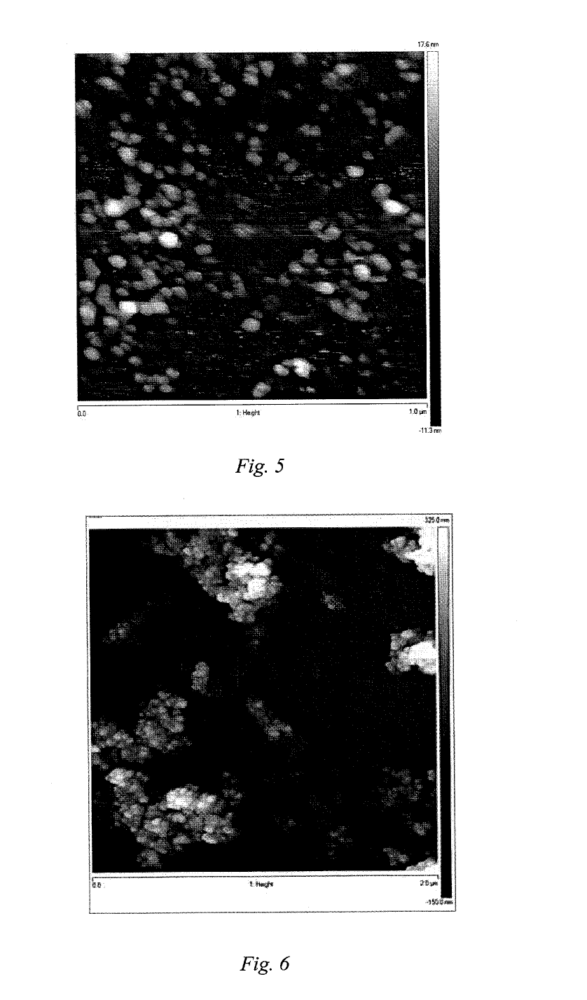

Agglomerates were formed from aqueous nanoparticle dispersions using a 1:12 mass ratio of epoxy-silane:amino-silane coated particles. To catalyze silica nanoparticle agglomeration, 1 mL of 10N sodium hydroxide solution was added dropwise to the silane nanoparticle dispersions and the dispersions were stirred overnight. Agglomerate deposition was carried out on an epoxy-silane coated microscope slide by submerging the slide in the agglomerate dispersion for 30 minutes followed by rinsing excess nanoparticles from the surface. After drying, the nanoparticle aggregate coated slide was submerged in a solution of 10 μL epoxy-silane in 25 mL ethanol. This nanoparticle decorated slide was subsequently submerged in a solution of 10 μL fluorosilane in 25 mL chloroform for 30 minutes. Contact angle measurements were made at several spots on the slide. In this manner, contact angles increased to 115°, indicating that the surface roughness increased. The root mean square (RMS) surface roughness was measured by AFM to be ˜4 nm, with an AFM image of the surface shown in FIG. 5.

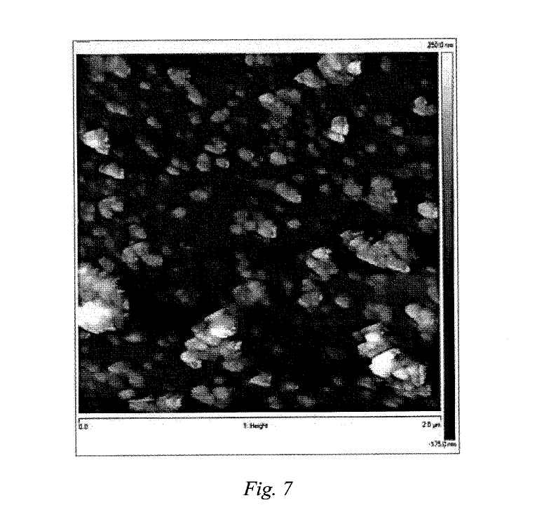

Agglomerates were formed by forming a dispersion from 10 μL total silane per 0.1 g of silicon oxide nanoparticles in ratios of either 1:3 or 3:1 amino-silane:epoxy-silane dispersed in 25 mL of ethanol. After 20 minutes of reaction, the dispersion was centrifuged at 7,000 rpm for 10 minutes followed by decanting the ethanol and re-dispersing the nanoparticles in 25 mL of ethanol. A GPTMS coated microscope slide was submerged in the dispersion and agitated. Upon removal, the nanoparticle coated slide was rinsed in ethanol and submerged for 30 minutes in a solution prepared by addition of 4 mL of 10 N sodium hydroxide in 50 mL of ethanol. The slide was rinsed with ethanol and dried under a nitrogen stream. Perfluoroalkyl silane functionalization of the surface was performed in the manner given above. Large increases in surface roughness were observed for these coated slides. AFM images of these samples can be seen in FIG. 6 and FIG. 7 for the 1:3 or 3:1 amino-silane:epoxy-silane dispersion treated silica nanoparticles, respectively. Surface area was more than doubled for both ratios, with a 114% increase seen for the 1:3 amino-silane:epoxy-silane ratio and a 133% increase seen for the 3:1 ratio, to provide contact angles of 125° for the 1:3 amino-silane:epoxy-silane ratio and 120° for the 3:1 amino-silane:epoxy-silane derived surfaces. Durability was maintained, even after 1,000 abrasion cycles simulating typical windshield wiper movement. Decreases in the water droplet contact angle of only a few degrees are seen, as shown in Table 2, below.

TABLE 2
Contact angles for agglomerated nanoparticles surfaces formed from
mixed amino and epoxy silane treatment of silica nanoparticles over
a series of abrasion cycles

| No. of | 1:3 Amino-silane:Epoxy-silane | 3:1 Amino-silane:Epoxy-silane |
|---|---|---|
| Cycles | Coating | Coating |
| 0 | 125° | 120° |
| 10 | 115° | 120° |
| 100 | 112° | 115° |
| 1,000 | 100° | 115° |

All publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A superhydrophobic nanoparticle coated article, comprising a plurality of ceramic nanoparticles attached to a surface of a substrate, wherein the ceramic nanoparticles are bound to the surface through a flexible linker, and wherein a fluorocarbon moiety is bound to at least the ceramic nanoparticles.

2. The superhydrophobic nanoparticle coated article according to claim 1, wherein the ceramic nanoparticles are metal oxide nanoparticles.

3. The superhydrophobic nanoparticle coated article according to claim 2, wherein the metal oxide nanoparticles are silicon oxide, aluminum oxide, titanium oxide, or any combination thereof.

4. The superhydrophobic nanoparticle coated article according to claim 1, wherein the flexible linker comprises a multiplicity of covalent bonds including a reaction product of a first functionality and a second complementary functionality, wherein a first portion of the flexible linker between the substrate and the reaction product is a first plurality of covalent bonds that connects the surface of the substrate to the first functionality prior to forming the reaction product and a second portion of the flexible linker between the ceramic nanoparticle and the reaction product is a second plurality of covalent bonds that connects the ceramic nanoparticle to the second functionality prior to the reaction to form the reaction product.

5. The superhydrophobic nanoparticle coated article according to claim 4, wherein the first functionality and the complementary functionality are provided by the surface of the substrate and the nanoparticles reacted with silane coupling agents.

6. The superhydrophobic nanoparticle coated article according to claim 5, wherein the silane coupling agents have the structure XₙR₃₋ₙSi(CH₂)ₘG, where X is H, Cl, OR′, NR′₂, OC(O)R′, where R′ is C₁ to C₃ alkyl; R is C₁ to C₃ alkyl; G is epoxy, NH₂, NHR″, OH, or C(O)OR′″, where R′″ is C₁ to C₃ alkyl; n is 1 to 3; and m is 3 to 8.

7. The superhydrophobic nanoparticle coated article according to claim 1, wherein the substrate is a transparent glass or a transparent polymer.

8. The superhydrophobic nanoparticle coated article according to claim 1, wherein the ceramic nanoparticle is less than 200 nm in cross-section.

9. The superhydrophobic nanoparticle coated article according to claim 1, wherein the fluorocarbon moiety is bound to at least the ceramic nanoparticle's surface as a plurality of fluorinated hydrocarbon moieties where each of the fluorinated hydrocarbon moieties is bound to the ceramic nanoparticles by at least one bond.

10. The superhydrophobic nanoparticle coated article according to claim 1, wherein the fluorinated hydrocarbon moiety results from reaction of the ceramic nanoparticle's surface with a fluorosilane having the structure: XₙR₃₋ₙSi(CH₂)₂(F₂)ₘCF₃, where X is H, Cl, OR′, NR′₂, OC(O)R′, where R′ is C₁ to C₃ alkyl; R is C₁ to C₃ alkyl; n is 1 to 3; and m is 1 to 17.

11. A method of preparing a superhydrophobic nanoparticle coated article according to claim 1, comprising:
providing a substrate having a multiplicity of first reactive groups on at least a portion of a substrate surface;
reacting a first portion of the multiplicity of the first reactive groups with a multiplicity of a substrate surface functionalizing agent that comprises a first complementary reactive group connected to a first functionality through a first plurality of covalent bonds, wherein at least one first bond is formed between the surface of the substrate and each of the substrate surface functionalizing agents to form a first functionality comprising substrate surface;
providing a multiplicity of ceramic nanoparticles, each of the ceramic nanoparticles having a multiplicity of second reactive groups on a ceramic nanoparticle's surface;
reacting a second portion of the multiplicity of the second reactive groups with a multiplicity of a ceramic nanoparticle's surface functionalizing agent that comprises a second complementary reactive group connected to a second complementary functionality through a second plurality of covalent bonds, wherein at least one second bond is formed between the ceramic nanoparticle's surface and each of the ceramic nanoparticle's surface functionalizing agents to form a multiplicity of second complementary functionality comprising ceramic nanoparticles;
depositing the multiplicity of second complementary functionality comprising ceramic nanoparticles on the first functionality comprising substrate;
reacting a multiplicity of the second complementary functionality attached to the multiplicity of second complementary functionality comprising ceramic nanoparticles with a multiplicity of the first functionality of the first functionality comprising substrate, wherein a reaction product of the first functionality and the second complementary functionality forms a flexible linker that consists of the reaction product, the first plurality of covalent bonds and the second plurality of covalent bonds wherein the multiplicity of the flexible linkers forms a ceramic nanoparticle decorated substrate; and
reacting the ceramic nanoparticle decorated substrate with a multiplicity of a fluorocarbon comprising reagent, wherein a second portion of the multiplicity of the second reactive groups reacts with the fluorocarbon comprising reagent to form covalent bonds that renders the surface of the ceramic nanoparticle decorated substrate coated with fluorocarbon moieties, and wherein a superhydrophobic nanoparticle coated article results.

12. The method according to claim 11, wherein the substrate surface functionalizing agent and the ceramic nanoparticle's surface functionalizing agent are dependently selected from silane coupling agents wherein the first functionality on a first silane coupling agent undergoes reaction with the second complementary functionality of second silane coupling agent.

13. The method according to claim 12, wherein the first silane coupling agent and the second silane coupling agent are selected from molecules with the structure: XₙR₃₋ₙSi(CH₂)ₘG, where X is H, Cl, OR′, NR′₂, OC(O)R′, where R′ is C₁ to C₃ alkyl; R is C₁ to C₃ alkyl; G is epoxy, NH₂, NHR″, OH, or C(O)OR′″, where R′″ is C₁ to C₃ alkyl; n is 1 to 3; and m is 3 to 8.

14. The method according to claim 11, wherein the fluorocarbon comprising reagent is a fluorosilane having the structure: XₙR₃₋ₙSi(CH₂)₂(F₂)ₘCF₃, where X is H, Cl, OR′, NR′₂, OC(O)R′, where R′ is C₁ to C₃ alkyl; R is C₁ to C₃ alkyl; n is 1 to 3; and m is 1 to 17.

15. A method of preparing a superhydrophobic nanoparticle coated article according to claim 1, comprising:
providing a substrate having a multiplicity of first reactive groups on at least a portion of a substrate surface;
reacting a first portion of the multiplicity of the first reactive groups with a multiplicity of a substrate surface functionalizing agent that comprises a first complementary reactive group connected to a first functionality through a first plurality of covalent bonds, wherein at least one first bond is formed between the surface of the substrate and each of the substrate surface functionalizing agents to form a first functionality comprising substrate surface;
providing a multiplicity of ceramic nanoparticles, each of the ceramic nanoparticles having a multiplicity of second reactive groups on a ceramic nanoparticle's surface;
reacting a second portion of the multiplicity of the second reactive groups with a multiplicity of a ceramic nanoparticle's surface functionalizing agent that comprises a second complementary reactive group connected to a second complementary functionality through a second plurality of covalent bonds, wherein at least one second bond is formed between the ceramic nanoparticle's surface and each of the ceramic nanoparticle's surface functionalizing agents to form a multiplicity of second complementary functionality comprising ceramic nanoparticles;
depositing the multiplicity of second complementary functionality comprising ceramic nanoparticles on the first functionality comprising substrate;
reacting a multiplicity of the second complementary functionality attached to the multiplicity of second complementary functionality comprising ceramic nanoparticles with a multiplicity of the first functionality of the first functionality comprising substrate, wherein a reaction product of the first functionality and the second complementary functionality forms a flexible linker that consists of the reaction product, the first plurality of covalent bonds and the second plurality of covalent bonds and wherein the multiplicity of the flexible linkers forms a ceramic nanoparticle decorated substrate;
reacting the ceramic nanoparticle decorated substrate with a multiplicity of the substrate surface functionalizing agent, wherein a multiplicity of the second complementary functionality of the ceramic nanoparticle decorated substrate reacts with a multiplicity of the first complementary functionality of the substrate surface functionalizing agent to form a multiplicity of the flexible linker to a multiplicity of the first complementary reactive groups;
hydrolyzing the first complementary reactive groups to form a hydrolyzed functionality ceramic nanoparticle decorated substrate; and
reacting the hydrolyzed functionality ceramic nanoparticle decorated substrate with a multiplicity of a fluorocarbon comprising reagent, wherein the fluorocarbon comprising reagent forms covalent bonds with the hydrolyzed functionality that renders the surface of the hydrolyzed functionality ceramic nanoparticle decorated substrate coated with fluorocarbon moieties, and wherein a superhydrophobic nanoparticle coated article results.

16. The method according to claim 15, wherein the substrate's surface functionalizing agent and the ceramic nanoparticle's surface functionalizing agent are dependently selected from silane coupling agents wherein the first functionality on a first silane coupling agent undergoes reaction with the second complementary functionality of second silane coupling agent.

17. The method according to claim 15, wherein the first silane coupling agent and the second silane coupling agent are selected from molecules with the structure: XₙR₃₋ₙSi(CH₂)ₘG, where X is H, Cl, OR′, NR′₂, OC(O)R′, where R′ is C₁ to C₃ alkyl; R is C₁ to C₃ alkyl; G is epoxy, NH₂, NHR″, OH, or C(O)OR′″, where R′″ is C₁ to C₃ alkyl; n is 1 to 3; and m is 3 to 8.

18. The method according to claim 15, wherein the fluorocarbon comprising reagent is a fluorosilane having the structure: XₙR₃₋ₙSi(CH₂)₂(F₂)ₘCF₃, where X is H, Cl, OR′, NR′₂, OC(O)R′, where R′ is C₁ to C₃ alkyl; R is C₁ to C₃ alkyl; n is 1 to 3; and m is 1 to 17.

19. A method of preparing a superhydrophobic nanoparticle coated article according to claim 1, comprising:
providing a substrate having a multiplicity of first reactive groups on at least a portion of a substrate surface;
reacting a first portion of the multiplicity of the first reactive groups with a multiplicity of a substrate surface functionalizing agent that comprises a first complementary reactive group connected to a first functionality through a first plurality of covalent bonds, wherein at least one first bond is formed between the surface of the substrate and each of the surface of the substrate functionalizing agents to form a first functionality comprising substrate surface;
providing a multiplicity of ceramic nanoparticles, each of the ceramic nanoparticles having a multiplicity of second reactive groups on a ceramic nanoparticle's surface wherein the second reactive groups undergo an equivalent reaction as the first reactive groups;
reacting a second portion of the multiplicity of the second reactive groups with a multiplicity of a ceramic nanoparticle's surface functionalizing agent that comprises a second complementary reactive group connected to a second complementary functionality through a second plurality of covalent bonds, wherein at least one second bond is formed between the ceramic nanoparticle's surface and each of the ceramic nanoparticle's surface functionalizing agents to form a multiplicity of second complementary functionality comprising ceramic nanoparticles;
providing an additional multiplicity of ceramic nanoparticles, each of the ceramic nanoparticles having a multiplicity of second reactive groups on a ceramic nanoparticle's surface;
reacting a second portion of the multiplicity of the second reactive groups with an additional multiplicity of the substrate surface functionalizing agent wherein at least one third bond is formed between the ceramic nanoparticle's surface and each of the substrate surface functionalizing agent to form a multiplicity of first complementary functionality comprising ceramic nanoparticles;
depositing the multiplicity of second complementary functionality comprising ceramic nanoparticles and the multiplicity of the first complementary functionality comprising ceramic nanoparticles on the first functionality comprising substrate;
reacting a multiplicity of the second complementary functionality attached to the multiplicity of second complementary functionality comprising ceramic nanoparticles with a multiplicity of the first functionality of the first functionality comprising substrate and the multiplicity of the first functionality of the first functionality comprising ceramic nanoparticles, wherein a reaction product of the first functionality and the second complementary functionality forms a flexible linker that consists of the reaction product, the first plurality of covalent bonds and the second plurality of covalent bonds, and wherein the multiplicity of the flexible linkers forms an aggregated ceramic nanoparticle decorated substrate;
reacting the aggregated ceramic nanoparticle decorated substrate with a multiplicity of the substrate surface functionalizing agent and with a multiplicity of the ceramic nanoparticle's surface functionalizing agent, wherein a multiplicity of the second complementary functionality reacts with a multiplicity of the first complementary functionality of the ceramic nanoparticle's surface functionalizing agent and the substrate surface functionalizing agent to form a multiplicity of the flexible linker to a multiplicity of the first complementary reactive groups and a multiplicity of the flexible linker to a multiplicity of the second complementary reactive groups;
hydrolyzing the first complementary reactive groups and the second complementary reactive groups to form a hydrolyzed functionality aggregated ceramic nanoparticle decorated substrate;
reacting the hydrolyzed functionality aggregated ceramic nanoparticle decorated substrate with a multiplicity of a fluorocarbon comprising reagent, wherein the fluorocarbon comprising reagent forms covalent bonds with the hydrolyzed functionality that renders the surface of the hydrolyzed functionality ceramic nanoparticle decorated substrate coated with fluorocarbon moieties, and wherein a superhydrophobic nanoparticle coated article results.

20. The method according to claim 19, wherein the substrate's surface functionalizing agent and the ceramic nanoparticle's surface functionalizing agent are dependently selected from silane coupling agents wherein the first functionality on a first silane coupling agent undergoes reaction with the second complementary functionality of second silane coupling agent.

21. The method according to claim 19, wherein the first silane coupling agent and the second silane coupling agent are selected from molecules with the structure: XₙR₃₋ₙSi(CH₂)ₘG, where X is H, Cl, OR′, NR′₂, OC(O)R′, where R′ is C₁ to C₃ alkyl; R is C₁ to C₃ alkyl; G is epoxy, NH₂, NHR″, OH, or C(O)OR′″, where R′″ is C₁ to C₃ alkyl; n is 1 to 3; and m is 3 to 8.

22. The method according to claim 19, wherein the fluorocarbon comprising reagent is a fluorosilane having the structure: XₙR₃₋ₙSi(CH₂)₂(F₂)ₘCF₃, where X is H, Cl, OR′, NR′₂, OC(O)R′, where R′ is C₁ to C₃ alkyl; R is C₁ to C₃ alkyl; n is 1 to 3; and m is 1 to 17.

23. The method according to claim 19, wherein the reaction with a multiplicity of the first functionality of the first functionality comprising substrate and the reaction with the multiplicity of the first functionality of the first functionality comprising ceramic nanoparticles occurs simultaneously.

24. The method according to claim 19, wherein the reaction with a multiplicity of the first functionality of the first functionality comprising substrate and the reaction with the multiplicity of the first functionality of the first functionality comprising ceramic nanoparticles occurs sequentially.
